(19) United States
(12) Patent Application Publication
(10) Pub. No.: US 2020/0027297 A1
(43) Pub. Date: Jan. 23, 2020

(54) VOTING TECHNIQUES USING VIRTUAL OR AUGMENTED REALITY

(71) Applicant: Dominion Voting Systems, Inc., Denver, CO (US)

(72) Inventors: Goran Obradovic, Toronto (CA); Monica Marics, Boulder, CO (US)

(21) Appl. No.: 16/518,649

(22) Filed: Jul. 22, 2019

Related U.S. Application Data
(60) Provisional application No. 62/702,245, filed on Jul. 23, 2018.

(51) Int. Cl. G07C 13/00; G06F 9/451; H04L 29/06; G06F 3/01; G06F 3/0482; G06F 3/12; G06F 3/0488

(52) U.S. Cl. CPC G07C 13/00; G06F 9/451; H04L 63/102; H04L 63/0861; G06F 3/1288; G06F 3/0482; G06F 3/1204; G06F 3/04883; G06F 3/1254; G06F 3/011

(57) ABSTRACT

Methods, systems, and devices for voting are described that provide for a virtual or augmented reality based voting. A virtual or augmented reality device may be coupled with a voting server and configured to authorize a voting session for a voter. The virtual or augmented reality device, upon authorization of the voter, may present an associated ballot to the voter, such that the voter may see a virtual ballot, and mark selections on the ballot using gestures. The ballot may presented across the full field of view and can be extensible to be as long as needed to satisfy any full face requirements of a jurisdiction. Virtually generated ballots may dynamically present different languages, size of fonts, colors, or combinations thereof.

### CROSS REFERENCES

The present Application for Patent claims priority to U.S. Patent Application No. 62/702,245, entitled “VOTING TECHNIQUES USING VIRTUAL OR AUGMENTED REALITY,” filed Jul. 23, 2018, assigned to the assignee hereof and incorporated by reference herein.

### BACKGROUND

The present invention relates to voting systems in general and, in particular, to voting techniques using virtual or augmented reality.

Electronic voting has been used in elections for some time and provides efficient vote and unambiguous vote collection and tabulation. Electronic votes may be cast by a voter using a direct-recording electronic (DRE) voting machine, in which the voter may electronically enter votes (e.g., via a touch-screen, audio interface, or other user interface). Optical scan systems may scan voter-marked paper ballots, which may have target areas that are evaluated by a computer that receives an image of the scanned ballot to determine if a vote is cast for a particular election (e.g., based on marks in a bubble or square next to a candidate's name on a ballot).

In such electronic systems, a voter may have to scroll through a number of screens in order to access each race or ballot measure that is to be voted. However, in some jurisdictions, voting laws may recite certain “full face” requirements that an entire ballot is to be viewed on a single side of a paper ballot or on a single electronic screen. In elections with a number of races, ballot measures, or combinations thereof, this may result in a relatively large paper ballot or relatively large electronic voting device screen, relatively small print on the ballots/screens, or combinations thereof. Thus, in some cases where DRE machines are used, such electronic voting machines may each be relatively large, taking up area both in a precinct voting location and in voting machine storage and transport. Furthermore, the size of such voting machines may allow others to view votes that are being made by a voter and thus may not provide as much privacy as some voters may prefer. Enhanced efficiency in voting on electronic voting machines, enhanced density and privacy at polling locations, and efficient setup, transport, and storage of voting machines may thus be desirable.

### SUMMARY

Methods, systems, and devices are described for voting using virtual or augmented reality voting systems. In some cases, a virtual or augmented reality device may be coupled with a voting server and configured to authorize a voting session for a voter. The virtual or augmented reality device, upon authorization of the voter, may present an associated ballot to the voter. The ballot may be presented via the virtual or augmented reality device such that the voter may see a virtual ballot, and mark selections on the ballot using gestures. Such a ballot provides enhanced privacy and is observable only by the voter, and any onlookers that may observe gestures made by the voter would be unable to identify a vote that corresponds to the observed gestures. The ballot may presented across the full field of view and can be extensible to be as long as needed to satisfy any full face requirements of a jurisdiction. Furthermore, such virtually generated ballots may dynamically present different languages, size of fonts, colors, or combinations thereof.

In some cases, ballots may provide access to rich information such as pictures, videos, animations, and links to other resources (e.g., candidate profiles, informational resources on candidates or issues, endorsements of one or more organizations, full text information for ballot initiatives or referenda being voted, etc.).

In some cases, the virtual or augmented reality device may record all or part of a voting session as a sequential voting stream and store the voting stream in memory for use as an audit trail. Such voting streams may provide eye movement, gaze targets, gaze durations, or combinations thereof, that may be used to analyze voter behavior when voting a ballot. In some cases, voting streams may be aggregated and provided for auditing of the election, analytics related to voting patterns, analytics related to voting sequences of voters, or any combination thereof. In some cases, the virtual or augmented reality device may be configured to provide a voter verified audit trail, such as a voter-verified paper audit trail (VVPAT) (e.g., via a printer that is accessed by the device) or voter-verified digital audit trail (VVDAT) (e.g., a digital signature generated from a voter confirmation of a list of selected votes).

In some aspects of the disclosure, virtual or augmented reality device may receive voter selections for one or more items on the ballot (e.g., via gesture monitoring or other input such as a keyboard, sip/puff input, eye gaze input, or audible command), and provide the received voter selections to a voting server. A tabulation server coupled with the voting server may receive the voter selections from the voting server and tabulate the received voter selections. In some cases, the virtual or augmented reality device may display a list of voter selections for the one or more items on the ballot after receiving the voter selections for the one or more items, and receive a voter verification of the list of voter selections, which may then be stored as a digital audit trail or printed as a paper audit trail. In some cases, the ballot presented to the voter includes one or more candidates that may be selected by the voter and a link that is selectable by the voter to request additional information for one or more of the candidates, and the additional information may be presented to the voter responsive to a selection of the link. Such the additional information may include, for example, one or more of additional information on a candidate, additional information on a ballot issue, a full text version of a ballot issue, an analysis of one or more candidates or ballot issues, a video and/or audio message from one or more candidates or organizations, or any combination thereof. In some cases, a biometric sensor (e.g., a fingerprint sensor, a retinal scan sensor, a facial recognition sensor, a biosensor, a genome sensor, or any combination thereof) may be coupled with the virtual reality device that is configured to perform biometric authentication of an identity of the voter.

In some aspects of the disclosure, a method for voting is provided. The method for voting may include configuring a voting server with ballot information and voter precinct information for an election, determining that a voter has been authorized for voting, generating, based at least on the voter authorization and the ballot information, a visual ballot for display with a virtual reality device, providing the visual ballot to the virtual reality device, receiving one or more voter selections for one or more items on the ballot from the voter via the virtual reality device, and providing the one or more voter selections to a tabulation server. In some cases, the virtual reality device of voting server may compile the one or more voter selections into a list of voter selections, generate a visual list of the one or more voter selections that is provided to the virtual reality device, and receive a voter verification that the list of the one or more voter selections represent votes of the voter from the virtual reality device. In some cases, all or a part of a voting session at the virtual reality device may be recorded as a voting stream that may be stored in memory for use as an audit trail.

### BRIEF DESCRIPTION OF THE DRAWINGS

FIG. 1 illustrates a voting system including components configured in accordance with aspects of the present disclosure.

FIG. 2 illustrates a block diagram of a voting system including components configured in accordance with aspects of the present disclosure.

FIG. 3 illustrates an image of an electronic ballot that a voter may complete in accordance with aspects of the present disclosure.

FIGS. 4A through 4C illustrate images of portions of a virtual ballot that may be provided to a voter in accordance with aspects of the present disclosure.

FIG. 5 illustrates a digital image that may be generated, stored, and provided to a voter to verify that voting selections have been properly recorded or read in accordance with aspects of the present disclosure.

FIG. 6 illustrates a block diagram of a virtual or augmented reality voting device in accordance with aspects of the present disclosure.

FIG. 7 illustrates a block diagram of a tabulation system in accordance with aspects of the present disclosure.

FIG. 8 illustrates a flow chart of a method for virtual or augmented reality voting in accordance with aspects of the present disclosure.

FIG. 9 illustrates a flow chart of a method for generating and analyzing voting streams in accordance with aspects of the present disclosure.

FIG. 10 illustrates a flow chart of another method for virtual or augmented reality voting in accordance with aspects of the present disclosure.

### DETAILED DESCRIPTION

Methods, systems, and devices are described for voting using virtual (or augmented) reality voting systems. In some cases, a virtual reality device may be used to present an associated ballot to a voter such that the voter may see a virtual ballot and mark selections on the ballot using gestures, and cast the ballot. In some cases, the virtual reality device may include a virtual reality headset that may be worn by the voter and that may record voting selections made by the voter. In other cases, other virtual reality devices may be used, such as a booth that provides video representations to a voter, for example. Furthermore, while various examples are provided herein that use virtual reality, systems that use augmented reality may also be used in some cases and used in accordance with techniques discussed herein.

By providing a virtual ballot using a virtual reality device, in some cases, voter privacy may be enhanced as the ballot may be observable only by the voter, and any onlookers that may observe gestures made by the voter would be unable to identify a vote that corresponds to the observed gestures. Additionally, the virtual ballot may presented across the full field of view without scrolling or different pages, and can be extensible to be as long as needed to satisfy any full face requirements of a jurisdiction. Furthermore, such virtually generated ballots may dynamically present different languages, size of fonts, colors, or combinations thereof. Additionally, ballots may provide access to rich information such as pictures, videos, animations, and links to other resources (e.g., candidate profiles, informational resources on candidates or issues, endorsements of one or more organizations, full text information for ballot initiatives or referenda being voted, etc.). In some cases, such rich information may be provided on any form of display (e.g., on a monitor or screen in proximity to a voter and that is separate from the virtual reality device) that may be viewed to obtain the information.

In some cases, the virtual reality device may record all or part of a voting session as a sequential voting stream and store the voting stream in memory for use as an audit trail. Such voting streams may provide eye movement, gaze targets, gaze durations, or combinations thereof, that may be used to analyze voter behavior when voting a ballot. In some cases, such movements may be stored in a manner that is not traceable to a specific voter (e.g., in a manner that is not linked to any voter-identifiable information, so as to protect voter privacy). In some cases, voting streams may be aggregated and provided for auditing of the election, analytics related to voting patterns, analytics related to voting sequences of voters, or any combination thereof. In some cases, the virtual or augmented reality device may be configured to provide a reviewable audit record of the votes selected using a voter verified audit trail, such as a voter-verified paper audit trail (VVPAT) (e.g., via a printer that is accessed by the device) or voter-verified digital audit trail (VVDAT) (e.g., a digital signature generated from a voter confirmation of a list of selected votes). In some cases, the virtual or augmented reality device may be configured to provide a printed ballot record of the votes selected using a ballot marking device (BMD) (e.g., via a printer that is accessed by the device).

Voting systems provided in accordance with various aspects of the disclosure may provide a number of benefits, such as providing a relatively lightweight voting system that provides efficient to storage, setup, and transport; that is easily extensible to long and complicated ballots; is able to provide information and content beyond binary choices on printed paper and that can include video/animation/links to recommendations or other information associated with an election; and that is backwards compatible with many existing tabulation systems and election management systems.

Aspects of the disclosure are initially described in the context of a voting system, followed by various examples of virtual reality based voting that illustrate several examples of techniques in accordance with the disclosure. Aspects of the disclosure are further illustrated by and described with reference to apparatus diagrams, system diagrams, and flowcharts that relate to voting techniques using virtual or augmented reality.

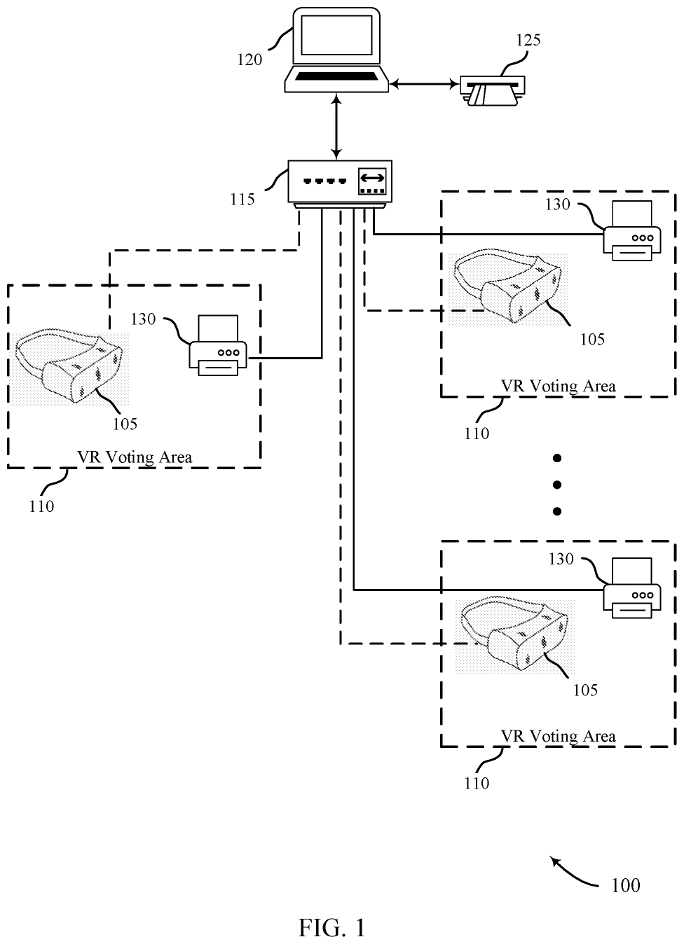

FIG. 1 illustrates an example of a voting system 100 in accordance with various aspects of the present disclosure. The voting system 100 includes a number of virtual reality devices 105 that may be located, in some examples, in virtual reality (VR) voting areas 110. In some examples, the voting system 100 may be a precinct voting system that is deployed at a voting precinct or voting center in which a number of different voters may concurrently vote in separate VR voting areas 110. In some cases, the VR voting areas 110 may be voting carrels with privacy walls and a curtain that may provide privacy to a voter. In some cases, one or more virtual reality devices 105 may not be located in a predefined VR voting area 110 or voting booth, and may simply be devices that may be provided to a voter who may stand or sit in an open room while voting, due to the privacy provided by the virtual reality device 105. In some cases, a virtual reality device 105 may be handed to a voter through an automobile window and the voter may vote while sitting in an automobile, or a number of virtual reality devices 105 may be handed to a number of voters sitting on a bus or in a van. In some cases, virtual reality devices 105 may be used in addition to one or more DRE machines that have, for example, a touch screen display or in addition to paper ballots that may be physically marked by a voter. In such cases, a voter may be given an option as to which method of voting they prefer.

A network hub 115 may provide a network connection to each virtual reality device 105. In the example of FIG. 1 the network connection is a wireless connection (e.g., a Wi-Fi connection, a Bluetooth™ connection, or other radio frequency connection), although in some cases wired connections (e.g., an Ethernet connection) may be provided. In some cases, a wired connection is provided for security purposes to load a virtual reality device 105 with a ballot to be voted by the voter, but which may be disconnected after a voter is authorized for voting and then reconnected once the voter completes voting to download a cast vote record, a voter-verified digital audit trail, a voting stream, or any combination thereof. In some cases, a ballot or paper audit trail may be printed such as using a printer 130.

In the system 100 of FIG. 1, the virtual reality devices 105 display visual information to the voter, either alone or in combination with audio information. The virtual reality device 105 may display options for one or more votes (e.g., candidate names, referendum answers, etc.) and to receive inputs from the voter to select one of the options as the voter's vote. In some cases, the inputs may be received through a gesture controller that monitors gestures of a voter. For example, a voter may raise their hand or a finger which may be monitored by the gesture controller to provide a corresponding display of the voter's hand or finger on the displayed ballot. The gesture controller may be a part of the virtual reality devices 105 (e.g., an optical sensor on a virtual or augmented reality headset that monitors gestures of a voter). In some cases, the gesture controller may be separate from the virtual reality devices 105 (e.g., an optical sensor in a voting booth that is pointed at the voter). As the voter moves their hand or finger toward a particular candidate name, this may be observed in the rendered virtual/augmented reality image and the voter may tap (or otherwise make a selection gesture, such as an X motion or check-mark motion) a selection area for the particular candidate. The voter, upon selection of a candidate, may observe the selection area changing to indicate that the particular candidate has been selected. In some cases, a further tap (or other selection gesture) may deselect a previously selected candidate and allow the voter to change a selection. In some cases, the system 100 may also include one or more accessible voting areas, which may be equipped with headphones 135 for audio ballots, an assistive device 140 for receiving inputs from a voter (e.g., a sip-puff interface, a TECLA box from Komodo OpenLab Inc. of Toronto Canada, etc.), and a joystick 145 that may be used for receiving inputs from a voter.

In the system 100, an administrative computer 120 may also be coupled with the network hub 115. The administrative computer 120, in some cases, may be used by an election official to generate voting sessions for a voter and initiate a voting session at a virtual reality device 105. In some cases, the administration computer 120 may be connected to the network hub 115 and may control the virtual reality device 105 to start a voting session. In some cases, an election official at the administration computer 120 may generate voter credentials that are programmed into a voter card at a card programmer 125, that may be provided to the voter and used to load a ballot at a virtual reality device 105 and initiate a voting session. The administration computer 120, in some cases, may include information for voters that are eligible to vote at a particular location and information for which particular districts that the voters are to vote in, and this information may be used to generate a ballot to be voted by the voter.

In some cases, the virtual reality devices 105 may be configured to record all or part of a voting session as a voting stream. Such a voting stream may be used, for example, as an audit trail to audit an election, or to provide analytics associated with voting selections. For example, a voting stream aggregation component (e.g., located at administration computer 120 or some other location) may store a number of different voting steams from a number of different voters and, after voting of an election is complete, may be accessed for auditing of the election, analytics related to voting patterns, analytics related to voting sequences of voters, or any combination thereof. In some cases, virtual reality devices 105 may include an eye movement monitor (e.g. as part of a gesture/gaze identification component) that captures one or more of eye movements, gaze targets, or gaze durations of the voter as the voter selections for the one or more items on the ballot are made. Such an eye movement monitor may include, for example, an optical component within the virtual reality device 105 that monitors eye movement and correlates eye movement to portions of the ballot that is being displayed to identify the portion of the ballot that is being read or looked at by the voter. The eye movements, gaze targets, gaze durations, or combinations thereof, may be stored as part of the voting stream. In some examples, the one or more eye movements, gaze targets, or gaze durations may be correlated with one or more of a selection by the voter, a number of times the voter reads one or more choices associated with a particular voter selection, an amount of time the voter looks at a choice before making a selection, additional information about one or more choices that is viewed by the voter (e.g., information provided through rich content that is accessible through the virtual ballot), or any combination thereof. In some cases, a voting stream may also include the time durations between events and across events, which may be stored in the voting stream to build a unique identifier (e.g., a fingerprint) of the voting stream session. A voting stream or vote session fingerprint may not include any voter identification information, but include a vote result and sequence (action and timing) in the voting stream.

In some cases, a virtual ballot that is displayed by virtual reality devices 105 may include one or more candidates or ballot issues that may be selected by the voter and a link that is selectable by the voter to request additional information for one or more of the candidates or ballot issues, and the additional information is presented to the voter through the virtual reality device 105 responsive to a selection of the link. For example, a voter may tap an information icon that is located on the virtual ballot, and the virtual reality device 105 may display text or a video that provides additional information on a candidate, additional information on a ballot issue, a full text version of a ballot issue, an analysis of one or more candidates or ballot issues, endorsements by one or more organizations, or any combination thereof. In some cases, the additional information may include a video having a predetermined duration that provides information on each of one or more candidates for a particular office.

In some cases, the virtual reality devices may include a media port (e.g. a wired or wireless connection) that is configured to read information indicating which of a number of different ballots is to be presented to the voter. In some cases, the virtual reality devices may include a biometric sensor that is configured to perform biometric authentication of an identity of the voter, such as, for example, a fingerprint sensor, a retinal scan sensor, a facial recognition sensor, a biosensor, a genome sensor, or any combination thereof.

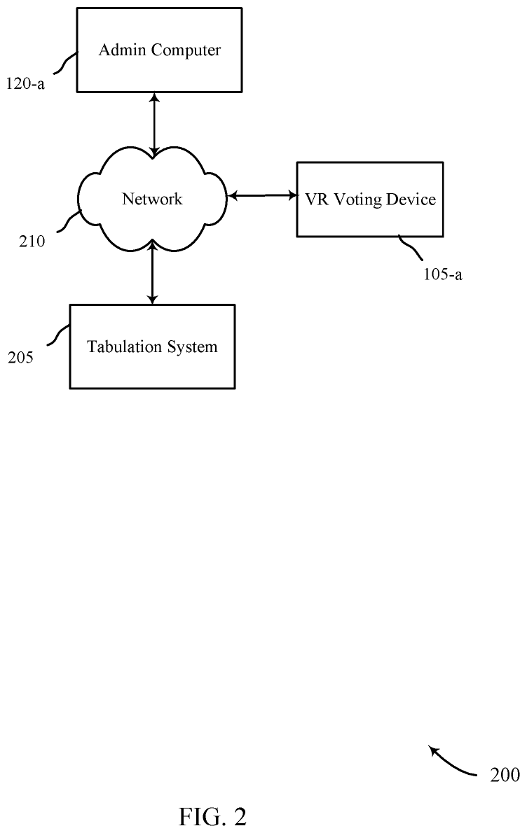

FIG. 2 illustrates a more generalized block diagram of a voting system 200 in accordance with various aspects of the present disclosure. The voting system 200 includes a virtual reality device 105-a which may be an example of a virtual reality device 105 of FIG. 1, a tabulation system 205, a communications network 210 which may include a network hub 115 such as in FIG. 1, and an administration computer 120-a. In the system 200 of FIG. 2, the virtual reality device 105-a, similarly as discussed with respect to FIG. 1, may include virtual reality headset that may display a virtual ballot to a voter and may monitor voter gestures to identify ballot selections by the voter.

The virtual reality device 105-a, after identifying votes entered by a voter, may generate a digital file containing a list of one or more votes that have been identified. The digital file may be a digital image file that may be used to display an image of the identified votes, or an audio file that may be used to play the identified votes. The digital file may be stored, and provided to the voter at the virtual reality device 105-a, and the voter may verify that the listed votes accurately represent the votes cast by the voter, which may be used to generate a cast vote record at the virtual reality device 105-a. The voter verification and the verified digital file may be stored as a voter-verified digital audit trail, and may in some cases be provided to the tabulation system 205 along with a cast vote record of the voter. In some cases, the digital audit trail file may include an image in any suitable image file such as, for example, a bitmap image, a jpeg image, a tiff image, a gif image, a png image, or a pdf image. In some cases, the digital audit trail file may include a voting stream of the voter. In some cases, a digital signature may be generated for the digital audit trail, such as a digital hash of the digital audit trail file that may provide enhanced security and tamper protection for the digital audit trail file.

The tabulation system 205 may be coupled with the virtual reality device 105-a either directly or via network 210. The tabulation system 205, in some cases, may receive a cast vote record from multiple virtual reality devices 105-a and tabulate results that may be used to determine the outcome of an election. The network 210, in some cases, is a local network that does not provide any connections to an external network or any devices that can be connected to an external network, thus providing a closed system that is relatively secure from any unauthorized access from outside parties. In some cases, tabulation results from the tabulation system 205 may be transferred (e.g., via a removable and portable memory device) to a central counting location (e.g., a county clerk or secretary of state office) for use in total vote counts and election certification. In some cases, as discussed above, the virtual reality device 105-a may provide the digital audit trail file and voter confirmation to the tabulation system 205, which may be provided as a single file or as separate files that may be linked to the cast vote record.

In some cases, post-voting ballot processing may be performed on a ballot that is cast by a voter. Such post-voting ballot processing may include, for example, a preferential voting reallocation process, an assignment of one or more write-in candidates, a removal of one or more votes based on voter ineligibility, or any combination thereof. In such cases, the tabulation system 205 may update the audit trail file and voter verification of the one or more votes based at least in part on the ballot processing, and store the updated information and voter verification in memory to provide the audit trail. In some cases, a log of the ballot processing may be appended to the audit trail. In some cases, following an initial count of votes for an election, a recount may be performed, and the audit trail may be used when re-tallying votes for one or more races or ballot issues. The administration computer 120-a, similarly as discussed above, may be used by an election official to generate voting sessions for a voter and initiate a voting session at the virtual reality device 105-a. In some cases, the ballot presented to the voter using the virtual reality device 105-a provides all voting information in a single view without requiring the voter to turn pages, open windows or scroll to view the ballot in its entirety. In some cases, the authentication of the voter includes identifying a preferred ballot language of the voter, and the associated ballot is presented to the voter using the identified preferred ballot language.

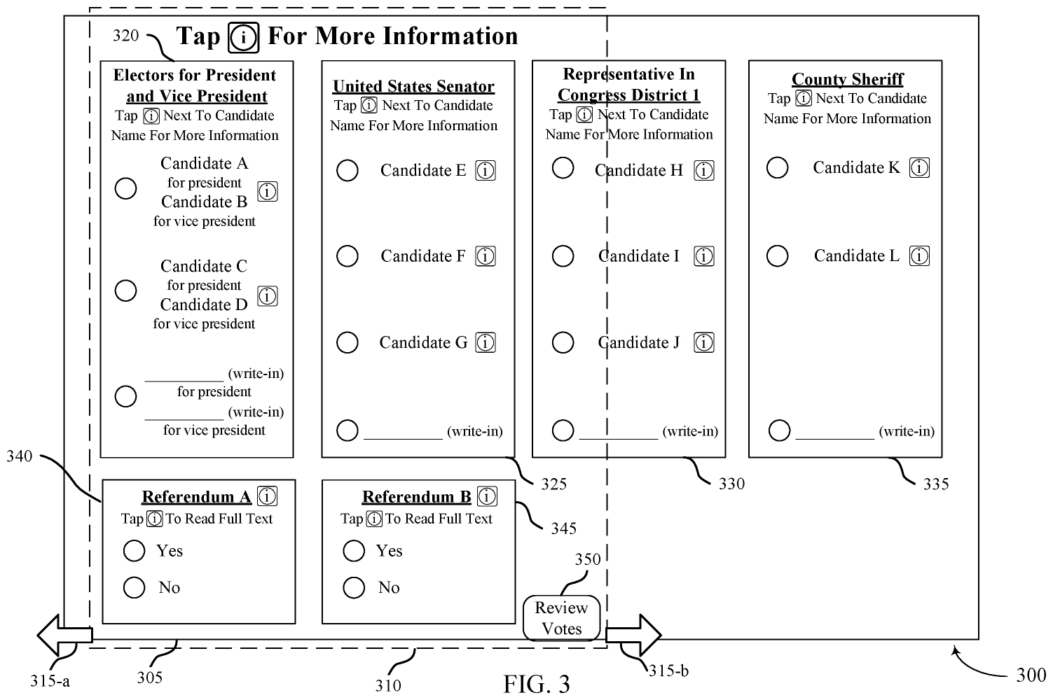

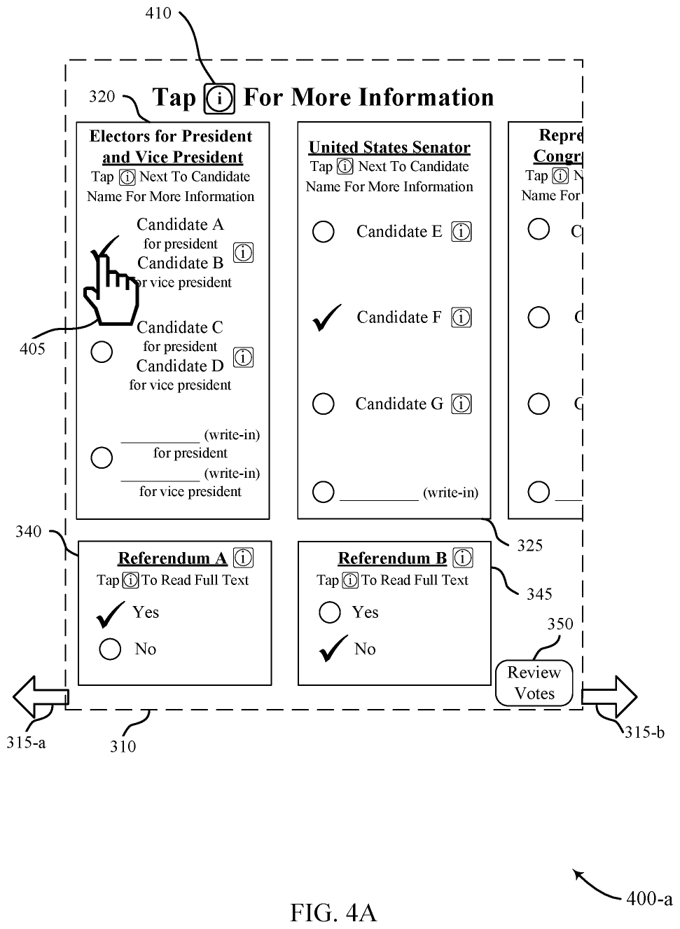

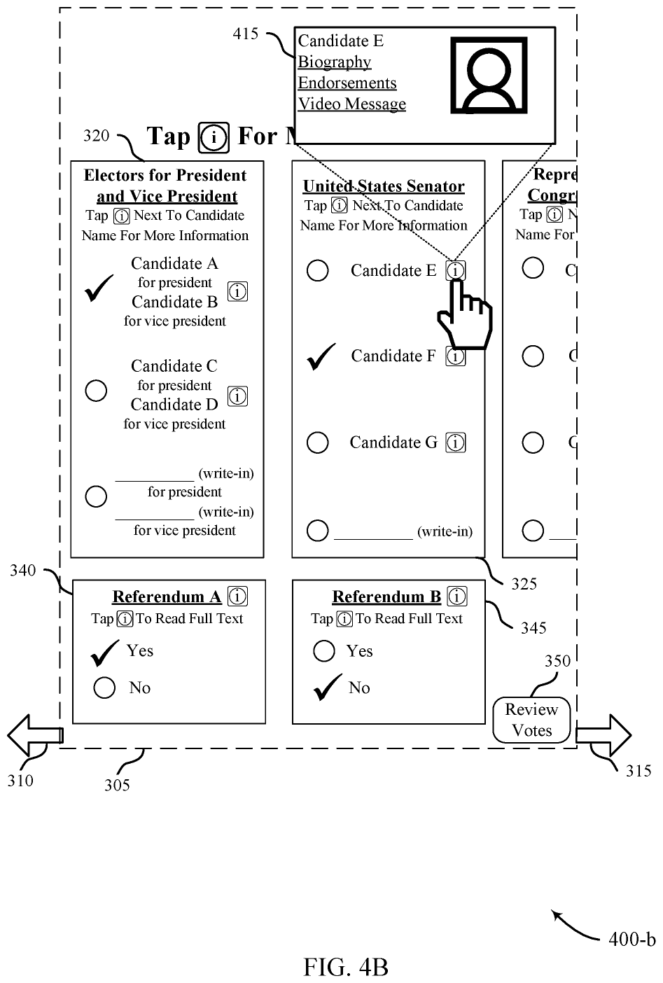

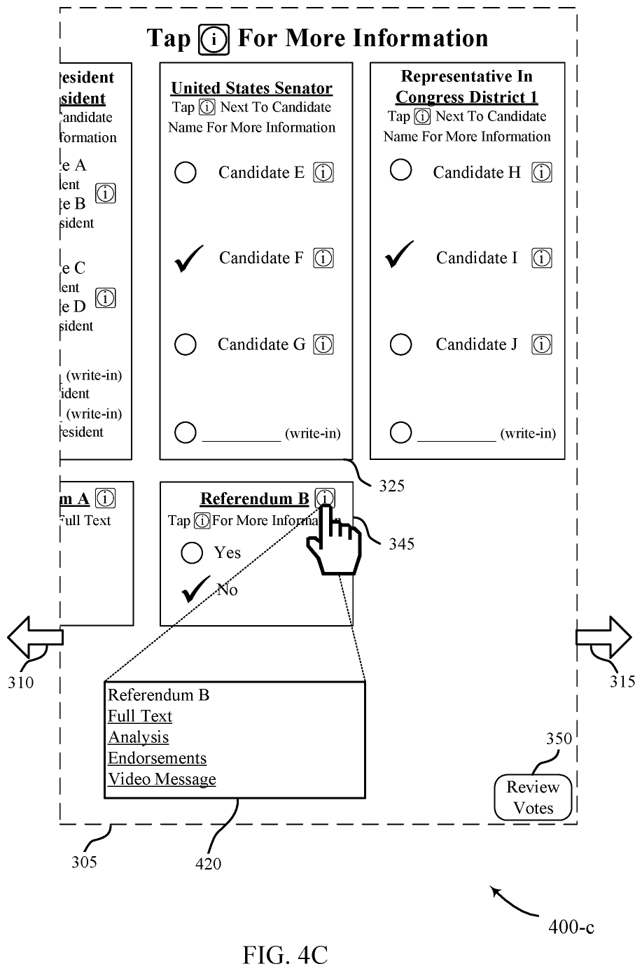

With reference now to FIG. 3, an example of an electronically voted ballot at an virtual reality voter interface 300 is described in accordance with various aspects of the present disclosure. In some examples, virtual reality voter interface 300 may be provided by virtual reality device 105 of FIGS. 1 or 2. The virtual reality voter interface 300 may be, display a virtual ballot 305 and, in this example a visible portion 310 of the virtual ballot 305 may be displayed using a virtual reality device. Arrows 315-a and 315-b represent movement of the visible portion on the virtual ballot 305 as, for example, a voter turns their head from side to side, or if the user gazes in a particular direction. The virtual ballot 305 may include a number of races or ballot issues (e.g., president, US senate, congressional representative, referendum, and county sheriff, as illustrated in this example) 320 through 345. In the example of FIG. 3, virtual ballot 305 indicates candidates for electors for president and vice president 320, candidates for US senator 325, candidates for representative in congressional district 1 330, county sheriff 335, ballot referendum A 340, and ballot referendum B 345. A voter may make selections on the virtual ballot, as will be discussed in more detail with respect to FIGS. 4A through 4C, and may select a review votes 350 selection upon voting for each of the items on the virtual ballot 305. In such a system, a voter may navigate through one or more votes that are to be made in an election at the voter interface 300.

With reference now to FIGS. 4A, 4B, and 4C, examples 400 of different selections are described in accordance with various aspects of the present disclosure. In the example of FIG. 4A, the voter has made a number of selections on the virtual ballot, in this example having selected Candidate A for president in area 320, candidate F for U.S. senator in area 325, selected ‘yes’ for Referendum A 340 and selected ‘no’ for referendum B 345. In this example, visible portion 310 does not show other ballot selections, although if the voter were to move their head or adjust their gaze the visible portion 310 may change, as illustrated in FIG. 4C. In some cases, a selection may be made by a voter moving their hand or finger, or other pointing device that is recognized by the virtual reality device, and making a selection (e.g., by tapping in proximity to a selection area or making a recognized gesture that indicates a selection). In the examples of FIGS. 4A through 4C, a hand icon 405 may appear on the virtual ballot and may move as the voter changes their hand location or gesture.

In some cases, a number of different information icons 410 may be located on the virtual ballot, and the selection of an information icon may result in additional information being displayed to the voter. In the example of FIG. 4B, the voter may select the information icon 410 associated with “candidate E” for the U.S. Senate race 325, which may cause the virtual reality device to display a window 415 that may provide additional information or links to additional information. In this example, window 415 may show a picture of the candidate, and have links to the candidates biography, endorsements, and a video message. Of course, numerous other types of information may be provided, and the examples provided herein are for purposes of illustration and discussion only and are not limiting on the types of information that may be provided. In such a manner, a voter may obtain relevant information that may be useful in deciding on which candidate to vote for in an election. In the example of FIG. 4C, the voter may select the information icon 410 associated with Referendum B 345, which may cause the virtual reality device to display a window 420 that may provide additional information or links to additional information. In this example, window 420 may allow the voter to display the full text of the referendum, an analysis of the referendum, endorsements associated with the referendum, and a video message.

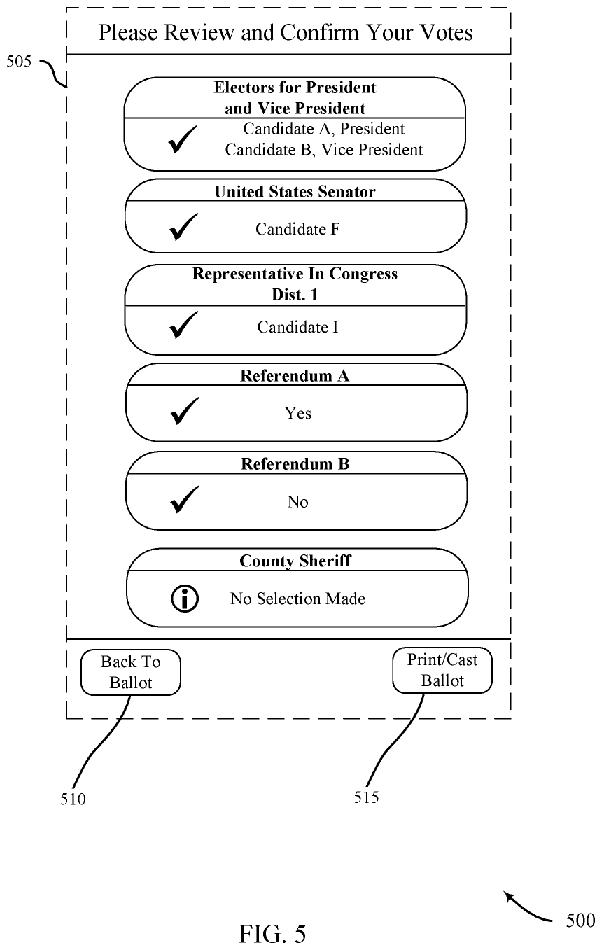

FIG. 5 illustrates an example of a verification screen 500 for a voted ballot at a virtual reality interface in accordance with various aspects of the present disclosure. In some examples, verification screen 500 may be generated by a virtual reality device 105 of FIG. 1 or 2. The verification screen 500 of this example includes a display 505 that lists selections from the virtual ballot. In some case, the displayed portion of the verification screen 500 may include a portion of the selections, and the voter may move their head or adjust their gaze to scroll up and down a list of selections made by the voter. In this example, upon reviewing the selections, the voter may select to print/cast 515 the ballot or go back to the ballot 510 to change one or more votes. In cases where a voter is satisfied with the selections made on the ballot, the voter may select print/cast ballot 515, which may generate a voter verification of the displayed image file and also initiate the virtual reality device to generate a cast vote record. If the voter is not satisfied with the selections, the voter may select back to ballot 510 to return to the ballot and modify one or more selections.

In some cases, the virtual reality device, prior to displaying the list of selections in the display 505, may identify the selections made by the voter and generate a digital image file that is stored in a memory of the device. The digital image file may be verified when the voter selects print/cast ballot 515, and the voter verification of the selections may be linked to the digital image file to create a voter-verified digital audit trail. As discussed above, the device may also generate a cast vote record and provide the cast vote record and voter-verified digital audit trail to a tabulation system for tabulation with other cast ballots by other voters.

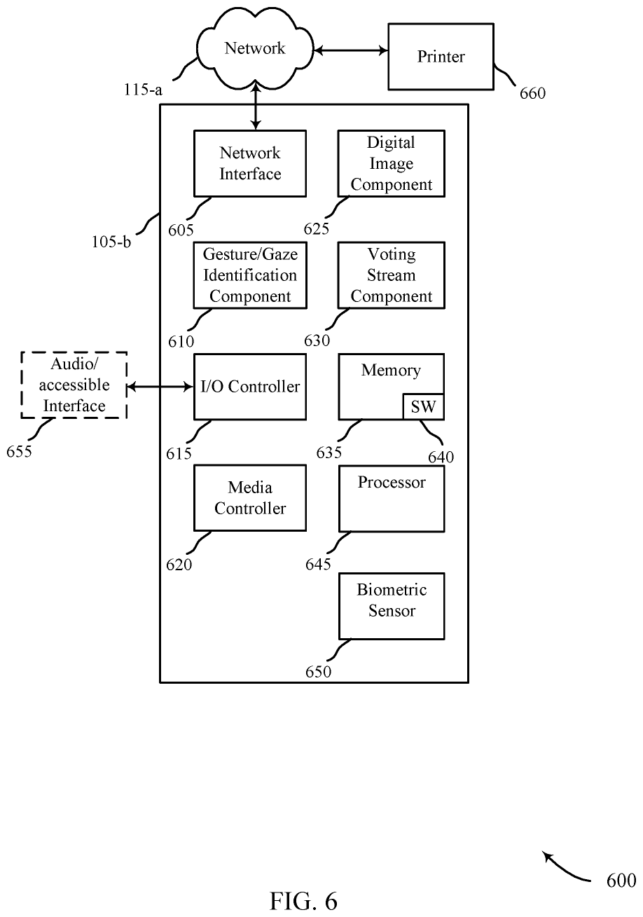

FIG. 6 shows a block diagram 600 of a virtual reality device 105-b that provides virtual reality voting in accordance with aspects of the present disclosure. Virtual reality device 105-b may be an example of aspects of virtual reality device 105 as described in FIG. 1 or 2. Virtual reality device 105-b may be coupled with a network hub 115-a (or other network) via network interface 605, and may include a gesture/gaze identification component 610, an I/O controller 615 (which may be coupled with an audio/accessible interface 655), a media controller 620 (which may display selected additional information or video to a voter), a digital image component 625 (which may generate displayed digital images), a voting stream component 630 that may capture a voting stream, a memory 635 that may include software 640 used to execute instructions to provide virtual reality voting as discussed herein. Virtual reality device 105-b may also include a processor 645 and a biometric sensor 650. Each of these components may be in communication with one another (e.g., via one or more buses). In some examples, virtual reality device 105-b may also be connected to a printer 660, either directly or through network 115-a.

Virtual reality device 105-b and/or at least some of its various sub-components may be implemented in hardware, software executed by a processor, firmware, or any combination thereof. If implemented in software executed by a processor, the functions of the virtual reality device 105-b and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The virtual reality device 105-b and/or at least some of its various sub-components may be physically located at various positions, including being distributed such that portions of functions are implemented at different physical locations by one or more physical devices. In some examples, virtual reality device 105-b and/or at least some of its various sub-components may be a separate and distinct component in accordance with various aspects of the present disclosure. In other examples, virtual reality device 105-b and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

In some cases, the gesture/gaze identification component 610 may identify one or more selections made by a voter on a ballot through gesture or gaze controls, and in some cases may provide information to the voting stream component 630. The media controller 620 may provide access to additional information that may be selected by a voter via a virtual ballot, such as video messages, audio messages, text information on candidates or ballot issues, endorsements, and the like. Digital image component 625 may generate a digital image of the virtual ballot for display to the voter, and may also generate a digital image file of the identified voting selections for voter confirmation. In some cases, gesture/gaze identification component 610 may receive the voter verification and provide a digital signature for the digital image file and verification. In cases where the virtual reality device 105-b includes a biometric sensor 650, such a sensor may be used to verify biometric information of a voter, as discussed above.

The processor 645 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). Processor 645 may be configured to execute computer-readable instructions stored in a memory to perform various functions (e.g., functions or tasks supporting voter-verified voting audit trails).

Memory 635 may include random access memory (RAM) and read only memory (ROM). The memory 635 may store computer-readable, computer-executable software 640 including instructions that, when executed, cause the processor to perform various functions described herein. In some cases, the memory 635 may contain, among other things, a basic input/output system (BIOS) which may control basic hardware or software operation such as the interaction with peripheral components or devices. Memory 635 may be a single memory component or distributed across two or more components that include memory.

Software 640 may include code to implement aspects of the present disclosure, including code to support virtual reality based voting. Software 640 may be stored in a non-transitory computer-readable medium such as system memory or other memory. In some cases, the software 640 may not be directly executable by the processor but may cause a computer (e.g., when compiled and executed) to perform functions described herein.

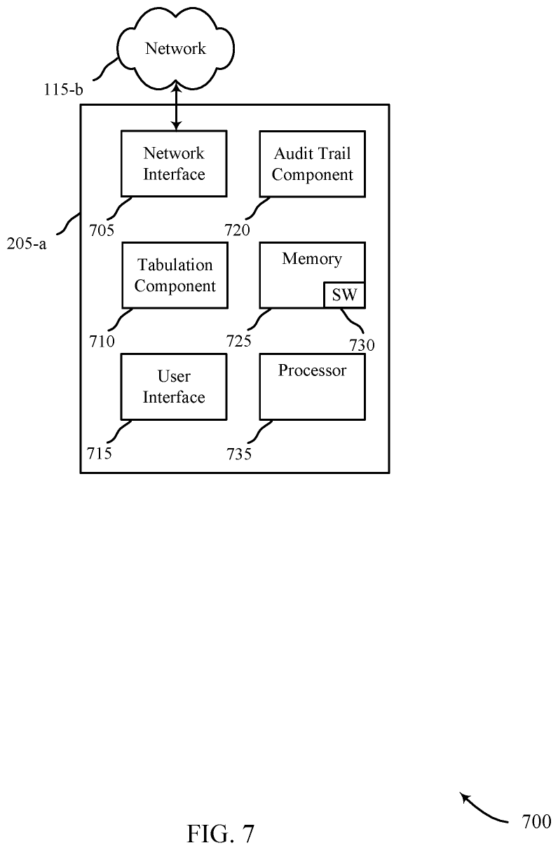

FIG. 7 shows a block diagram 700 of a tabulation system 205-a that provides virtual reality voting in accordance with aspects of the present disclosure. Tabulation system 205-a may be an example of aspects of tabulation system 205 as described in FIG. 2. Tabulation system 205-a may be coupled with a network hub 115-b (or other network) via network interface 705, and may include a tabulation component 710, a user interface 715, an audit trail component 720, and a memory 725 that may include software 730 used to execute instructions to provide voter verified digital audit trails as discussed herein. Tabulation system 205-a may also include a processor 735. Each of these components may be in communication with one another (e.g., via one or more buses).

Tabulation system 205-a and/or at least some of its various sub-components may be implemented in hardware, software executed by a processor, firmware, or any combination thereof. If implemented in software executed by a processor, the functions of the tabulation system 205-a and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The tabulation system 205-a and/or at least some of its various sub-components may be physically located at various positions, including being distributed such that portions of functions are implemented at different physical locations by one or more physical devices. In some examples, tabulation system 205-a and/or at least some of its various sub-components may be a separate and distinct component in accordance with various aspects of the present disclosure. In other examples, tabulation system 205-a and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

In some cases, the tabulation component 710 may receive vote information from a virtual reality device (e.g., a virtual reality device 105 as discussed in FIGS. 1-6), which may include a cast vote record, and use the information to tabulate one or more votes cast by a voter in an election with votes of other voters in the election. In some cases, audit trail component 720 may receive a voter-verified digital audit trail file and may store the file in memory 725 with a link to the cast vote record. In some cases, processor 735 may perform post-voting ballot processing on a ballot which may include, for example, a preferential voting reallocation process, an assignment of one or more write-in candidates, a removal of one or more votes based on voter ineligibility, or any combination thereof. In such cases, the tabulation component 710 may update the digital image and voter verification of the one or more votes based at least in part on the ballot processing, and store the updated digital image and voter verification in memory 725 to provide the voter-verified digital audit trail.

Processor 735 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 735 may be configured to operate a memory array using a memory controller. In other cases, a memory controller may be integrated into processor 735. Processor 735 may be configured to execute computer-readable instructions stored in a memory to perform various functions (e.g., functions or tasks supporting virtual or augmented reality based voting).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support virtual reality based voting. Software 730 may be stored in a non-transitory computer-readable medium such as system memory or other memory. In some cases, the software 730 may not be directly executable by the processor but may cause a computer (e.g., when compiled and executed) to perform functions described herein. In some cases, tabulation system 205-a may utilize an operating system such as iOS®, ANDROID®, MS-DOS®, MS-WINDOWS®, OS/2®, UNIX®, LINUX®, or another known operating system. In other cases, tabulation system 205-a may represent or interact with a modem, a keyboard, a mouse, a touchscreen, or a similar device via user interface 715.

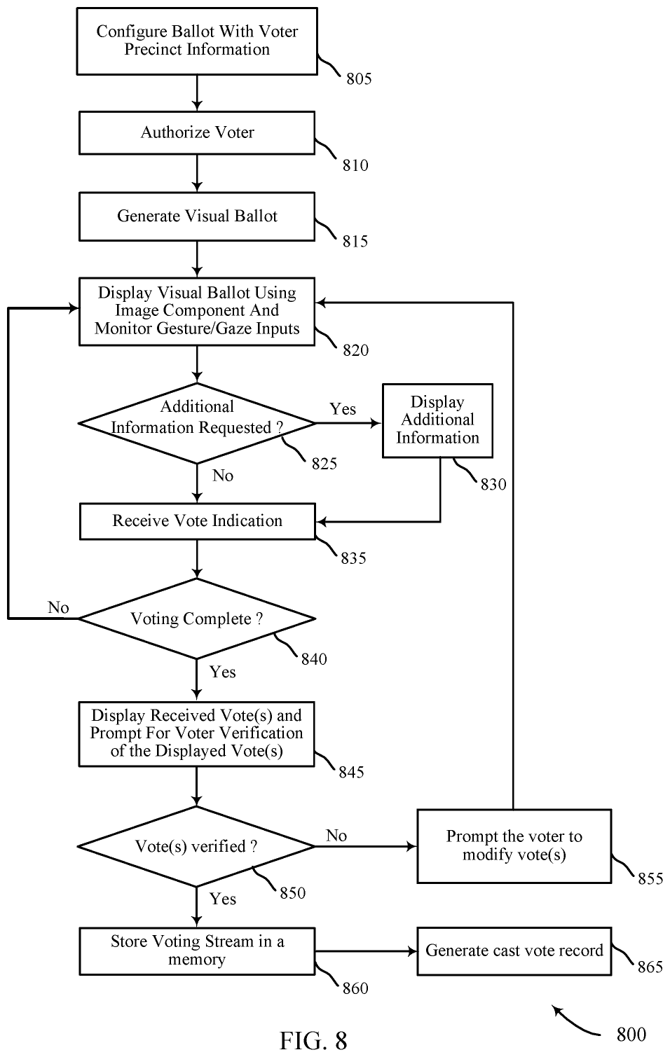

FIG. 8 shows a flowchart illustrating a method 800 for virtual reality based voting in accordance with aspects of the present disclosure. The operations of method 800 may be implemented by a virtual reality device or its components as described herein. For example, the operations of method 800 may be performed by a virtual reality device 105 described in FIG. 1, 2, or 6. In some examples, a virtual reality device may execute a set of codes to control the functional elements of the device to perform the functions described below. Additionally or alternatively, the virtual reality device may perform aspects of the functions described below using special-purpose hardware.

At 805 the virtual reality device may be configured with a ballot with voter precinct information. The operations of 805 may be performed according to the methods described herein. In certain examples, aspects of the operations of 805 may be performed by a processor in conjunction with network interface which may receive ballot information from an administrative computer such as illustrated in FIG. 1 or 2.

At 810 the virtual reality device may authorize the voter. The operations of 810 may be performed according to the methods described herein. In certain examples, aspects of the operations of 810 may be performed by a processor in conjunction with network interface which may receive voter authorization from an administrative computer such as illustrated in FIG. 1 or 2.

At 815 the virtual reality device may generate a visual ballot. The operations of 815 may be performed according to the methods described herein. In certain examples, aspects of the operations of 815 may be performed by a digital image component and memory as described with reference to FIG. 6.

At 820 the virtual reality device may display the visual ballot using digital component and monitor gesture/gaze inputs. The operations of 820 may be performed according to the methods described herein. In certain examples, aspects of the operations of 820 may be performed by the digital image and gesture/gaze identification components as described with reference to FIG. 6.

At 825 the virtual reality device may determine whether additional information is requested for any portion of the displayed ballot. The operations of 825 may be performed according to the methods described herein. In certain examples, aspects of the operations of 825 may be performed by a gesture/gaze identification component as described with reference to FIG. 6. In some examples, such a determination may be made by selecting an additional information input that is displayed with the ballot, and the virtual reality device may determine that a selection is made.

In the event that additional information is requested, at 830 the virtual reality device may display the additional information. The operations of 830 may be performed according to the methods described herein. In certain examples, aspects of the operations of 830 may be performed by the digital image component as described with reference to FIG. 6.

At 835, the virtual reality device may receive a vote indication. The operations of 835 may be performed according to the methods described herein. In certain examples, aspects of the operations of 835 may be performed by the gesture/gaze identification component as described with reference to FIG. 6.

At 840 the virtual reality device may determine if the voting is complete. The operations of 840 may be performed according to the methods described herein. In certain examples, aspects of the operations of 830 may be performed by the gesture/gaze identification component as described with reference to FIG. 6, such as if it is determined that the voter has selected a review votes selection.

If the voting is not complete at 840, the operations of 820 are repeated. If voting is complete at 840, the virtual reality device, at 845, may display the received vote(s) and prompt for voter verification of the displayed vote(s). The operations of 840 may be performed according to the methods described herein. In certain examples, aspects of the operations of 840 may be performed by the digital image and gesture/gaze identification components as described with reference to FIG. 6.

At 850 the virtual reality device may determine if the vote(s) are verified. The operations of 850 may be performed according to the methods described herein. In certain examples, aspects of the operations of 850 may be performed by the gesture/gaze identification component as described with reference to FIG. 6, such as if it is determined that the voter has selected a verification selection or go back to votes selection.

If the vote(s) are not verified at 850, the virtual reality device at 855 may prompt the voter to modify vote(s) and continue with operations at block 820. The operations of 855 may be performed according to the methods described herein. In certain examples, aspects of the operations of 855 may be performed by a gesture/gaze identification component as described with reference to FIG. 6.

If the vote(s) are verified at 850, the virtual reality device at 850 may store a voting stream of the voter actions leading to the verified vote(s) in a memory. The operations of 850 may be performed according to the methods described herein. In certain examples, aspects of the operations of 850 may be performed by a voting stream component and memory as described with reference to FIG. 6.

At 865 the virtual reality device may generate a cast vote record with the identified vote(s) and the voter verification. The operations of 865 may be performed according to the methods described herein. In certain examples, aspects of the operations of 865 may be performed by a processor as described with reference to FIG. 6.

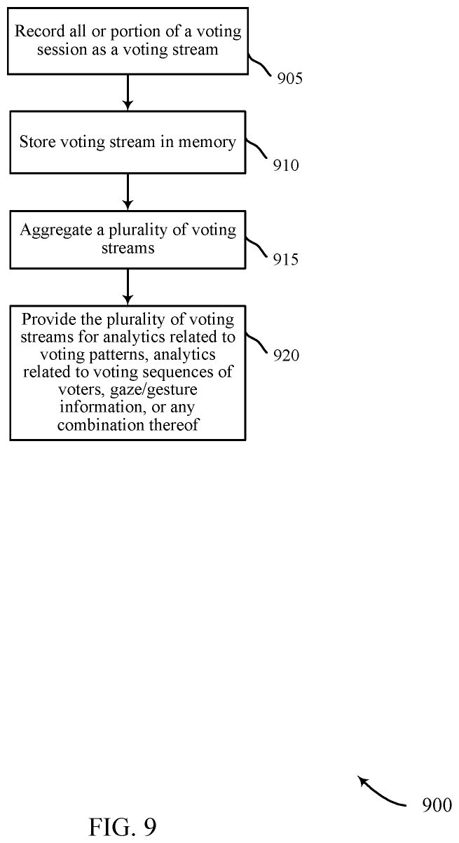

FIG. 9 shows a flowchart illustrating a method 900 for virtual reality voting in accordance with aspects of the present disclosure. The operations of method 900 may be implemented by a virtual reality device and tabulation server, or components thereof, as described herein. For example, the operations of method 900 may be performed by a virtual reality device 105 and tabulation server 205 described in FIG. 1, 2, 6, or 7. In some examples, devices may execute a set of codes to control the functional elements of the device to perform the functions described below. Additionally or alternatively, aspects of the functions described below using special-purpose hardware.

At 905 the virtual reality device may record all or portion of a voting session as a voting stream. The operations of 905 may be performed according to the methods described herein. In certain examples, aspects of the operations of 905 may be performed by a voting stream component as described with reference to FIG. 6. In some cases, the voting stream may be identified through the digital image and gesture/gaze identification components as described with reference to FIG. 6.

At 910 the virtual reality device may store the voting stream in memory. The operations of 910 may be performed according to the methods described herein. In certain examples, aspects of the operations of 910 may be performed by the voting stream component and memory as described with reference to FIG. 6.

At 915 a plurality of voting streams may be aggregated. The operations of 915 may be performed according to the methods described herein. In certain examples, aspects of the operations of 915 may be performed by a processor and memory at a tabulation system 205 as described with reference to FIG. 7.

At 920 the plurality of voting streams may be provided for analytics related to voting patterns, analytics related to voting sequences of voters, gaze/gesture information, or any combination thereof. The operations of 920 may be performed according to the methods described herein. In certain examples, aspects of the operations of 920 may be performed by a processor and memory at a tabulation system 205 as described with reference to FIG. 7.

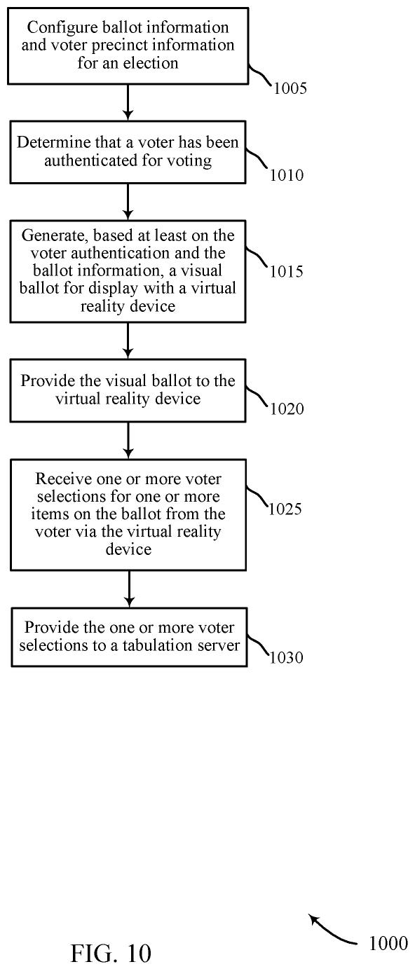

FIG. 10 shows a flowchart illustrating a method 1000 for virtual reality based voting in accordance with aspects of the present disclosure. The operations of method 1000 may be implemented by a virtual reality device or its components as described herein. For example, the operations of method 1000 may be performed by a virtual reality device 105 described in FIG. 1, 2, or 6. In some examples, a virtual reality device may execute a set of codes to control the functional elements of the device to perform the functions described below. Additionally or alternatively, the virtual reality device may perform aspects of the functions described below using special-purpose hardware.

At 1005 the virtual reality device may configure ballot information and voter precinct information for an election. The operations of 1005 may be performed according to the methods described herein. In certain examples, aspects of the operations of 1005 may be performed by a network interface as described with reference to FIG. 6.

At 1010 the virtual reality device may determine that a voter has been authenticated for voting. The operations of 1005 may be performed according to the methods described herein. In certain examples, aspects of the operations of 1005 may be performed by a network interface component as described with reference to FIG. 6. In some cases, the inputs from the voter may be received through the audio/accessible interface at the voter terminal.

At 1015 the virtual reality device may generate, based at least on the voter authentication and the ballot information, a visual ballot for display with a virtual reality device. The operations of 1015 may be performed according to the methods described herein. In certain examples, aspects of the operations of 1005 may be performed by a digital image component as described with reference to FIG. 6.

At 1020 the virtual reality device may provide the visual ballot to the virtual reality device. The operations of 1020 may be performed according to the methods described herein. In certain examples, aspects of the operations of 1020 may be performed by a digital image component as described with reference to FIG. 6.

At 1025 the virtual reality device may receive one or more voter selections for one or more items on the ballot from the voter via the virtual reality device. The operations of 1025 may be performed according to the methods described herein. In certain examples, aspects of the operations of 1025 may be performed by a gesture/gaze component and memory as described with reference to FIG. 6.

At 1030 the virtual reality device may provide the one or more voter selections to a tabulation server. The operations of 1030 may be performed according to the methods described herein. In certain examples, aspects of the operations of 1030 may be performed by a network interface as described with reference to FIG. 6.

It should be noted that the methods described above describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A voting system, comprising:
a voting server configured with ballot information and voter information for an election;
a virtual reality device coupled with the voting server and configured to authorize a voting session for a voter, present an associated ballot to the voter, receive voter selections for one or more items on the ballot, and provide the received voter selections to the voting server; and
a tabulation server coupled with the voting server that receives the voter selections from the voting server and tabulates the received voter selections.

2. The voting system of claim 1, further comprising:
a gesture controller coupled with the virtual reality device configured to capture one or more gestures of the voter as the voter selections for the one or more items on the ballot.

3. The voting system of claim 1, wherein the virtual reality device is further configured to display a list of voter selections for the one or more items on the ballot after receiving the voter selections for the one or more items, and receive a voter verification of the list of voter selections.

4. The voting system of claim 1, wherein the virtual reality device is further configured to record all or part of a voting session as a voting stream and store the voting stream in memory for use as an audit trail.

5. The voting system of claim 4, wherein the voting stream is not traceable back to the voter to protect voter privacy.

6. The voting system of claim 4, further comprising:
a voting stream aggregation component that stores a plurality of voting steams from a plurality of different voters and, after voting of an election is complete, is accessible for auditing of the election, analytics related to voting patterns, analytics related to voting sequences of voters, or any combination thereof.

7. The voting system of claim 4, further comprising:
an eye movement monitor coupled with the virtual reality device configured to capture one or more of eye movements, gaze targets, or gaze durations of the voter as the voter selections for the one or more items on the ballot are made, and wherein the eye movements, gaze targets, gaze durations, or combinations thereof, are stored as part of the voting stream.

8. The voting system of claim 7, wherein the one or more eye movements are correlated with one or more of a selection of a voter selection, a number of times the voter reads one or more choices associated with a particular voter selection, an amount of time the voter looks at a choice before making a selection, additional information about one or more choices that is viewed by the voter, or any combination thereof.

9. The voting system of claim 1, wherein ballot presented to the voter includes one or more candidates that may be selected by the voter and a link that is selectable by the voter to request additional information for one or more of the candidates, and wherein the additional information is presented to the voter responsive to a selection of the link.

10. The voting system of claim 9, wherein the additional information comprises one or more of additional information on a candidate, additional information on a ballot issue, a full text version of a ballot issue, an analysis of one or more candidates or ballot issues, or any combination thereof.

11. The voting system of claim 9, wherein the additional information comprises visual or audio information associated with one or more candidates or ballot issues.

12. The voting system of claim 9, wherein the additional information comprises a link to a third-party site that provides voter information.

13. The voting system of claim 9, wherein the additional information comprises a video having a predetermined duration that provides information on each of the one or more candidates.

14. The voting system of claim 1, wherein ballot presented to the voter using the virtual reality device provides all voting information in a single view without requiring the voter to turn pages, open windows or scroll to view the ballot in its entirety.

15. The voting system of claim 1, wherein the authentication of the voter includes identifying a preferred ballot language of the voter, and the associated ballot is presented to the voter using the identified preferred ballot language.

16. The voting system of claim 1, further comprising:
a media port coupled with the virtual reality device that is configured to read information indicating which of a plurality of different ballots is to be presented to the voter.

17. The voting system of claim 1, further comprising:
a biometric sensor coupled with the virtual reality device that is configured to perform biometric authentication of an identity of the voter.

18. The voting system of claim 17, wherein the biometric sensor comprises a fingerprint sensor, a retinal scan sensor, a facial recognition sensor, a biosensor, a genome sensor, or any combination thereof.

19. The voting system of claim 1, wherein the virtual reality device is further configured to present the associated ballot to the voter as an audio ballot, or as an audio plus visual ballot.

20. The voting system of claim 1, further comprising:
a printer coupled with the voting server that is configured to print a paper audit trail for the received voter selections.

21. A method for voting, comprising:
configuring a voting server with ballot information and voter precinct information for an election;
determining that a voter has been authorized for voting;
generating, based at least on the voter authorization and the ballot information, a visual ballot for display with a virtual reality device;
providing the visual ballot to the virtual reality device;
receiving one or more voter selections for one or more items on the ballot from the voter via the virtual reality device; and
providing the one or more voter selections to a tabulation server.

22. The method of claim 21, wherein the virtual reality device includes a display for displaying the visual ballot and a gesture controller configured to capture one or more gestures of the voter as the voter selections for the one or more items on the ballot.

23. The method of claim 21, further comprising:
compiling the one or more voter selections into a list of voter selections;
generating a visual list of the one or more voter selections;
providing the visual list of the one or more voter selections to the virtual reality device; and
receiving a voter verification that the list of the one or more voter selections represent votes of the voter from the virtual reality device.

24. The method of claim 23, further comprising:
storing the visual list of the one or more voter selections and the voter verification in a memory as a voter verified digital audit trail.

25. The method of claim 21, further comprising:
recording all or a part of a voting session at the virtual reality device as a voting stream; and
storing the voting stream in memory for use as an audit trail.

26. The method of claim 25, further comprising:
storing a plurality of voting streams at a voting stream aggregation component; and
providing the plurality of voting streams, after voting of an election is complete, for analytics related to voting patterns, analytics related to voting sequences of voters, or any combination thereof.

27. The method of claim 25, further comprising:
capturing one or more of eye movements, gaze targets, or gaze durations of the voter as the voter selections for the one or more items on the ballot are made; and
storing the eye movements as part of the voting stream.

28. The method of claim 27, wherein the one or more eye movements, gaze targets, or gaze durations are correlated with one or more of a selection of a voter selection, a number of times the voter reads one or more choices associated with a particular voter selection, an amount of time the voter looks at a choice before making a selection, additional information about one or more choices that is viewed by the voter, or any combination thereof.

29. The method of claim 21, wherein ballot presented to the voter includes one or more candidates or selections related to one or more ballot issues and a link that is selectable by the voter to request additional information for one or more of the candidates or ballot issues, and wherein the method further comprises:
receiving an indication that the voter has selected the link; and
providing the additional information to the virtual reality device for presentation to the voter responsive to the selection of the link.

30. The method of claim 29, wherein the additional information comprises one or more of additional information on a candidate, additional information on a ballot issue, a full text version of a ballot issue, an analysis of one or more candidates or ballot issues, or any combination thereof.

31. The method of claim 29, wherein the additional information comprises a video having a predetermined duration that provides information on each of the one or more candidates.

32. The method of claim 21, wherein the determining that the voter has been authorized comprises:
determining that a first ballot of a plurality of different ballots is to be displayed to the voter; and
determining a preferred language of the first ballot.

33. The method of claim 21, wherein the generating the visual ballot comprises:
reading, at a media port, information indicating which of a plurality of different ballots is to be presented to the voter.

34. The method of claim 21, wherein the determining that the voter has been authenticated for voting comprises:
identifying biometric information associated with the voter;
activating a biometric sensor coupled with the virtual reality device to perform biometric authentication of an identity of the voter; and
authenticating the voter responsive to a successful biometric authentication of the voter.

35. The method of claim 34, wherein the biometric sensor comprises a fingerprint sensor, a retinal scan sensor, a facial recognition sensor, a biosensor, a genome sensor, or any combination thereof.

36. The method of claim 21, further comprising:
generating, based at least on the voter authorization and the ballot information, an audio ballot for providing auditory representations of available selections of the ballot information using the virtual reality device; and
providing the audio ballot to the virtual reality device.

37. The method of claim 21, further comprising:
receiving a voter verification that the one or more voter selections represent the votes cast by the voter; and
printing a paper audit trail with the received voter selections.
